(19) United States
(12) Patent Application Publication
(10) Pub. No.: US 2008/0147453 A1
(43) Pub. Date: Jun. 19, 2008

(54) SYSTEM AND METHOD FOR END USERS TO CREATE A WORKFLOW FROM UNSTRUCTURED WORK

(76) Inventors: Sandra L. Kogan, Newton Centre, MA (US); Hardy Groeger, Bad Lippspringe (DE); Andrew L. Schirmer, Andover, MA (US)

Correspondence Address: HOFFMAN, WARNICK & D'ALESSANDRO LLC, 75 STATE STREET, 14TH FLOOR, ALBANY, NY, 12207, US

(21) Appl. No.: 11/612,754

(22) Filed: Dec. 19, 2006

(51) Int. Cl. G06Q 10/00

(52) U.S. Cl. 705/7

(57) ABSTRACT

A workflow automating system provides a solution to allow users to create a workflow process from work they have done or work they plan to do and integrate it into their work environment. The system of the present invention allows a user to automatically record the steps of a process, as the user performs the steps, so that these recorded steps may be used some time later as a workflow. Once saved, these steps may be removed or modified by, such as, assigning the responsibility for performing the step to another party or by resequencing the step to another stage of the workflow, or additional steps may be added to the workflow. This can be accomplished very easily without the need to learn a tool, scripting language or how to code a workflow. Further, a history log of the user's steps in his or her ad hoc work processes is created. The user has the ability to then examine the history log and to select key steps from the history log to create a new workflow or to include in an existing workflow. Sufficient details of each step are recorded by the system of the present invention and such details are passed to the workflow so that the user has no need to learn a tool, scripting language or how to code the workflow. The level, or amount, of details captured by the system of the present invention is configurable by the user so that more details are captured or less details are captured—depending upon the user's needs and desires. The workflow automating system allows a user to tag objects, such as emails, calendar entries, documents, URLs, etc., for use in an existing workflow or for use in a future workflow. This is especially helpful when a user knows that an object is important but has no need for the object in an existing workflow but will need the object for a future workflow for an upcoming project, for instance. A listener component records actions on each page and tracks information as to what a user did on a page, e.g., information relating to the interactions with cooperating portlets and what was done with those portlets, utilizing a new schema for normalizing the data which is to be recorded by the listener. The new schema describes the data to be recorded in order to later use that data for automating workflows. It may include such information as: a general name and description of step that is being recorded; where to navigate the user at runtime to actually perform that action within an instance of such workflow; and a URI of the content element that the action was executed on. Using a workflow editor tool, the user can decide which parts of the data are relevant or are points of variability.

### FIELD OF THE INVENTION

The invention relates generally to creating workflows, and, more particularly, to a system and method for end users to create workflows in an ad hoc or unstructured work environment.

### BACKGROUND OF THE INVENTION

In the past, typically, workflows or business processes have been predefined, formal processes or workflows that are structured and planned out in advance of execution. This works well when the work itself is structured and well-defined, generally in an environment which is mature so that the processes themselves are mature and ironed out.

However, many times, especially in today's marketplace, the work environment is changing quite rapidly so that formal, predefined workflows and processes are obsolete by the time they are implemented. This presents a problem for the end user who may ultimately perform the same task countless times while waiting for the workflow to be defined and implemented. By the time the automated process is implemented, it may be that the user is no longer performing that particular sequence of tasks or the sequence has changed (or the tasks themselves have changed). Also, people do unstructured work and the tasks they perform throughout the day are not predefined such that a formal process can be defined and implemented. In fact, many people only recognize the need for an automated process after repeating the same tasks many times. Only then, the end user must go to a formal tool to define the steps/tasks and workflow or need to put in a request to have the automated process built for them (by a developer, process modeler, or external contractor). Users express frustrations because they don't know where to begin as they, themselves, are not process modelers. They realize that they're doing something that they just did (repeating the same set of steps over again . . . ) but have to start over again (sometimes many times) in order to understand and record the exact sequence of steps the performed so that the specific request having the precise series of steps may be articulated to a developer or process modeler. This is time consuming, frustrating and error-prone as steps may be missed, misrecorded or there may be a miscommunication between the end user and the process modeler. The process modeler also lacks the domain knowledge to understand the details of the process and the nuances which may make a big difference in the encoding and execution. Of course, many times, processes need to be “tweaked” as it is often difficult to have it perfectly defined and implemented the first time around. This involves another round of discussions/communications between the end user and the developer further exacerbating the problems of getting the automated process implemented.

Sometimes, however, the process is very familiar to the user such that it is not so troublesome to record. In these cases, he or she would note the process steps in text format or design a flow using a graphic tool such as Microsoft Office Visio® (or SmartDraw.com's SmartDraw®) and then pass it on to a developer to get it built. The problem arises as resources, many times, are limited and the resources required to automate the end user's process are consumed in building those processes deemed important, and/or business critical. Most times, it is deemed too costly and time consuming to build processes to support each user in all of his or her ‘everyday work’.

The best solution, of course, is for the end user to have the ability to create the workflow or automated process themselves—as they are the most knowledgeable in how the process should operate and the most interested in obtaining a working implementation of the automated process. However, standard workflow tools are too complex for end users and are also not integrated into their work environment making them difficult to use.

There are systems which attempt to accomplish this goal. For example, Apple's new Tiger operating system (OS) (see http://www.apple.com/macosx/overview/) attempts to accomplish this by offering a graphical environment for building scripts and complex applications which will enable users to build workflows by dragging and dropping actions on a pipeline (such as with Apple Computer's Automator). Currently, however, script development in that environment requires knowledge of Applescript. Automator comes complete with a library of hundreds of Actions and developers are adding new actions all the time. Actions are written in Applescript (See here for more details on how to create actions: http://developer.apple.com/macosx/automator.html)

Each Action is designed to perform a single task, such as finding linked images in a web page, or renaming a group of files. Actions from the Automator library are added in sequence to a Workflow document. Each Action in the Workflow corresponds to an individual step that you would normally do to accomplish your task. Developers are extending the reach of Automator by creating new Actions for their applications.
http://www.apple.com/macosx/features/automator/

Of course, systems which record a user's steps have been known for some time. For instance, there are systems which record macros by recording the steps and details of the steps so that the user doesn't need manually code the macro—thereby alleviating the need for the user to have knowledge of such macro programming languages as C or Visual Basic. (IBM's Lotus 1-2-3® and Microsoft's Excel® spreadsheet software packages still offer a record macro feature that is a standard part of the Visual Basic for Application (VBA) tools). When learning to use macros, users could record a series of keys/steps and then play it back, look at the code and modify it. This is a powerful and successful end user programming strategy.

While there are many macro tools available, and macros can be strung together to execute in a particular order, there are no macro tools that allow users to build a workflow. This entails assigning a step to a user and/or a user role. Effective workflows entails, e.g., assigning different people to different steps. For instance, in a workflow, one user may have many roles and be assigned to several steps and one role can be assigned to many users. This is simply not possible with the simple macro record function.

In view of the foregoing, a need exists to overcome these problems by providing a system and method for an end user to design his or her own workflow or business process for his or her unstructured work and/or processes.

### BRIEF SUMMARY OF THE INVENTION

The system and method of the present invention provides a solution to allow users to create a workflow from work they have just done or work they plan to do, and integrate it into their work environment. By providing a solution which allows users to create processes from their unstructured work, or from work they've just done, creating workflows is an attainable, tangible and realistic goal—something users can create without the need of involving third parties such as developers or process modelers.

In one embodiment of the present invention, a user is able to utilize the invention to automatically record the steps of a process, as the user performs the steps, so that these recorded steps may be used some time later as a workflow. Once saved, these steps may be removed or modified by, such as, assigning the responsibility for performing the step to another party (which can be identified by username or role) or by resequencing the step to another stage of the workflow, or additional steps may be added to the workflow or deleted from the workflow. This can be accomplished very easily without the need to learn a tool, scripting language or how to code a workflow.

In another embodiment of the present invention, a history log of the user's steps in his or her ad hoc work processes. The user has the ability to then examine the history log and to select key steps from the history log to create a new workflow or to include in an existing workflow. Sufficient details of each step are recorded by the system of the present invention and such details are passed to the workflow so that the user has no need to learn a tool, scripting language or how to code the workflow. The level, or amount, of details captured by the system of the present invention is configurable by the user so that more details are captured or less details are captured—depending upon the user's needs and desires.

In yet another embodiment of the present invention, the system of the present invention allows a user to tag objects, such as emails, calendar entries, documents, URLs, etc., for use in an existing workflow or for use in a future workflow. This is especially helpful when a user knows that an object is important but has no need for the object in an existing workflow but will need the object for a future workflow for an upcoming project, for instance. Or, one object is important to several different workflow processes.

The present invention introduces a listener component which records actions on each page and tracks information as to what a user did on a page, e.g., information relating to the interactions with cooperating portlets and what was done with those portlets.

The present invention further introduces a new schema for normalizing the data which is to be recorded by the listener. The new schema (referred to herein as “action recording schema”) describes the data to be recorded in order to later use that data for automating workflows. It may include such information as a general name and description of step that is being recorded; where to navigate the user at runtime to actually perform that action within an instance of such workflow; and a URI of the content element that the action was executed on. Using a workflow editor tool, the user can decide which parts of the data are relevant or are points of variability.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 is a block diagram showing the general components of a computer system that can be used to automated a workflow according to an embodiment of the present invention.

FIG. 2 shows an example of a process which could be automated using the workflow automating system illustrative according to an embodiment of the invention.

FIG. 3 shows an illustrative process flow diagram for generating an application according to an embodiment of the invention.

FIG. 4 shows an illustrative process flow diagram for analyzing application data according to an embodiment of the invention.

FIG. 5 shows an illustrative execution environment for an application according to an embodiment of the invention.

FIG. 6 illustrates a history log of a process to be recorded.

FIG. 7 illustrates a workflow editor tool in a logical block diagram form.

FIG. 8 comprises FIGS. 8A and 8B illustrating a “new hire checklist”.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As used herein, unless otherwise noted, the term “set” means one or more (i.e., at least one) and the phrase “any solution” means any now known or later developed solution. Additionally, the term “data store” means any type of memory, storage device, storage system, and/or the like, which can temporarily or permanently store electronic data, and which can be included in a storage and/or memory hierarchy (collectively referred to herein as a “memory hierarchy”) for a computer system.

As indicated above, the invention provides a solution for end users and lines-of-business users (LOBs) to easily create workflows or business processes from their “unstructured” or “ad hoc” work. For purposes of this application, “LOB” shall mean either a line-of-business user or any one particular business activity, such as accounting or sales. A line-of-business user is a business user whose primary goals are business related. In other words, they are using the software as means to an end. For example, a LOB user is concerned about lowering costs, increasing customer satisfaction, and maximizing revenue opportunities. It is important to note that LOB users are generally not professional programmers, and they don't want to become programmers. They require tools that do not look and feel like tools. Of course, users would naturally wish to utilize these tools on handhelds as well. (A Handheld device (also known as handheld computer or simply handheld) is a pocket-sized computing device, typically utilising a small visual display screen for user output and a miniaturized keyboard for user input. In the case of the Personal digital assistant the input and output are combined into a touch-screen interface. Along with mobile computing devices such as laptops and smart phones, personal digital assistants (PDAs) are becoming increasingly popular amongst those who require the assistance and convenience of a conventional computer, in environments where carrying one would not be practicable.

The following are typical handhelds:
Information appliance
Smartphone
Personal digital assistant
Mobile phone
Personal Communicator
Handheld game console
Ultra-Mobile PC
Handheld television

### The system and method of the present invention solves this by being device independent.

In one embodiment, the system of the present invention allows users to record steps as the steps are performed and save the sequence of steps for later use as a workflow. In a second embodiment, the system of the present invention allows users to select key steps from a history log and, in a third embodiment, the system of the present invention allows users to tag objects for inclusion in an existing workflow or future workflow.

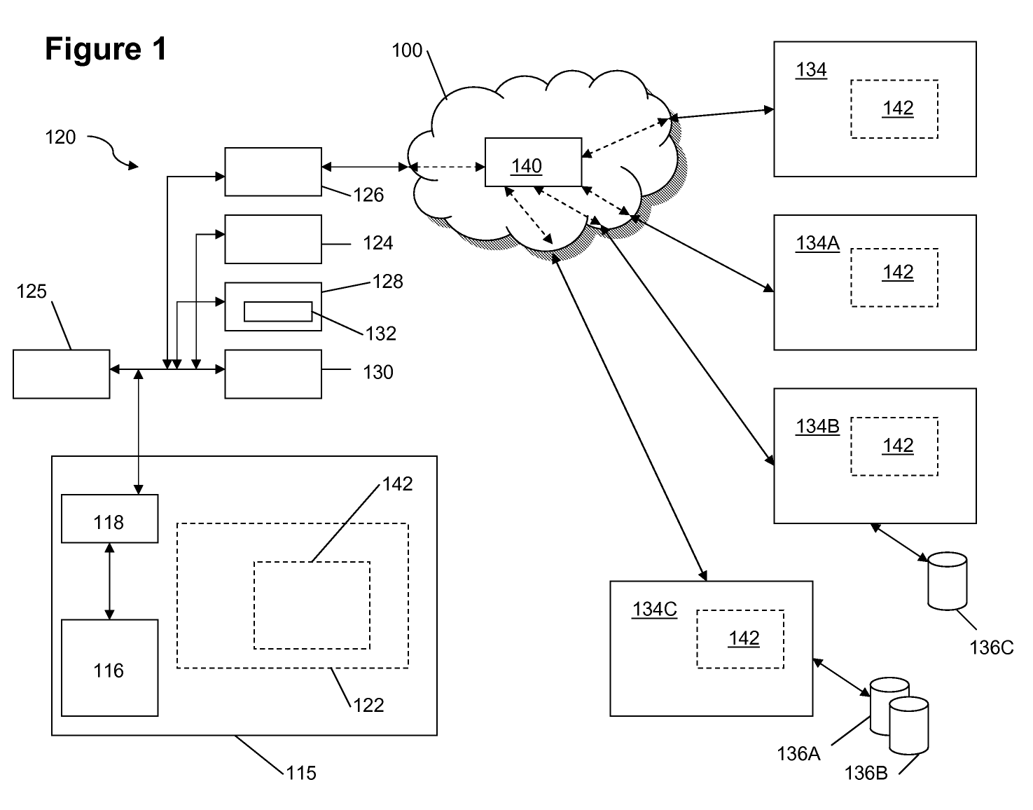

With reference to the accompanying drawings, a detailed description of the present invention will be provided. FIG. 1 is a block diagram showing the components of a general purpose computer system 120 connected to an electronic network 100, such as a computer network. The computer network 100 can also be a public network, such as the Internet or Metropolitan Area Network (MAN), or other private network, such as a corporate Local Area Network (LAN) or Wide Area Network (WAN), or a virtual private network (VPN). As shown in FIG. 1, the computer system 120 includes a central processing unit (CPU) 125 connected to a system memory 115. The system memory 115 typically contains an operating system 116, a BIOS (basic input/output system) driver 118, and application programs 122. Operating System (OS) 116 may be one of many OSs such as those for personal computers as Linux, Microsoft Windows, Mac and Unix. (An OS is a software program that manages the hardware and software resources of a computer and performs basic tasks, such as controlling and allocating memory, prioritizing the processing of instructions, controlling input and output devices, facilitating networking, and managing files.) In addition, the computer system 120 contains input devices 124 such as a mouse and a keyboard 132, and output devices such as a printer 130 and a display monitor 128.

The computer system generally includes a communications interface 126, such as an Ethernet card, to communicate to the electronic network 100. Other computer systems 134, 134A, 134B and 134C may also be connected to the electronic network 100. One skilled in the art would recognize that the above system describes the typical components of a computer system connected to an electronic network. It should be appreciated that many other similar configurations are within the abilities of one skilled in the art and all of these configurations could be used with the methods of the present invention.

Furthermore, one skilled in the art would recognize that the other computer systems 134B and 134C could consist of a database server and/or an application software server connected to databases 136A/136B and 136C, respectively for performing tasks requested by computer 120 or other computers 134 and 134A. Further, other computers 134 and 134A, in this example, could be personal computers assigned to other personnel within the company or organization.

In addition, one skilled in the art would recognize that the “computer” implemented invention described further herein may include components that are not computers per se but include devices such as Internet appliances and Programmable Logic Controllers (PLCs) that may be used to provide one or more of the functionalities discussed herein. Furthermore, “electronic” networks are generically used to refer to the communications network connecting the processing sites of the present invention, including implementation by using optical or other equivalent technologies.

One skilled in the art would recognize that other system configurations and data structures and electronic/data signals could be provided to implement the functionality of the present invention. All such configurations and data structures are considered to be within the scope of the present invention.

Within the network 100, represented by a cloud, the workflow automating server 140 resides and is connected to computer 120, and other computers 134, 134A, 134B, and 134C. It should be noted that one skilled in the art would recognize that the workflow automating server 140, while residing in the network cloud 100 of the present example, could be connected to any computer directly, by way of one or more interconnected corporate networks or one or more Internet networks and it will still perform in the same manner. In the preferred embodiment, the workflow automating server 140 of the present invention is an IBM® Workplace® Server. In addition, in the preferred embodiment, the computers (120, 134, 134A, 134B and 134C) each have an IBM® Workplace® client application installed thereon so that the workflow automating server 140 and the computers (120, 134, 134A, 134B and 134C) may communicate utilizing specified protocols and functions. The workflow automating server 140 of the present invention comprising an IBM® Workplace® Server and the computers (120, 134, 134A, 134B and 134C) each having an IBM® Workplace® client application installed thereon will be discussed in further detail herein below. More information may be obtained regarding IBM Workplace software at www.ibm.com or, more specifically, http://www.142.ibm.com/software/workplace/products/product5.nsf/wdocs/workplaceoverview.

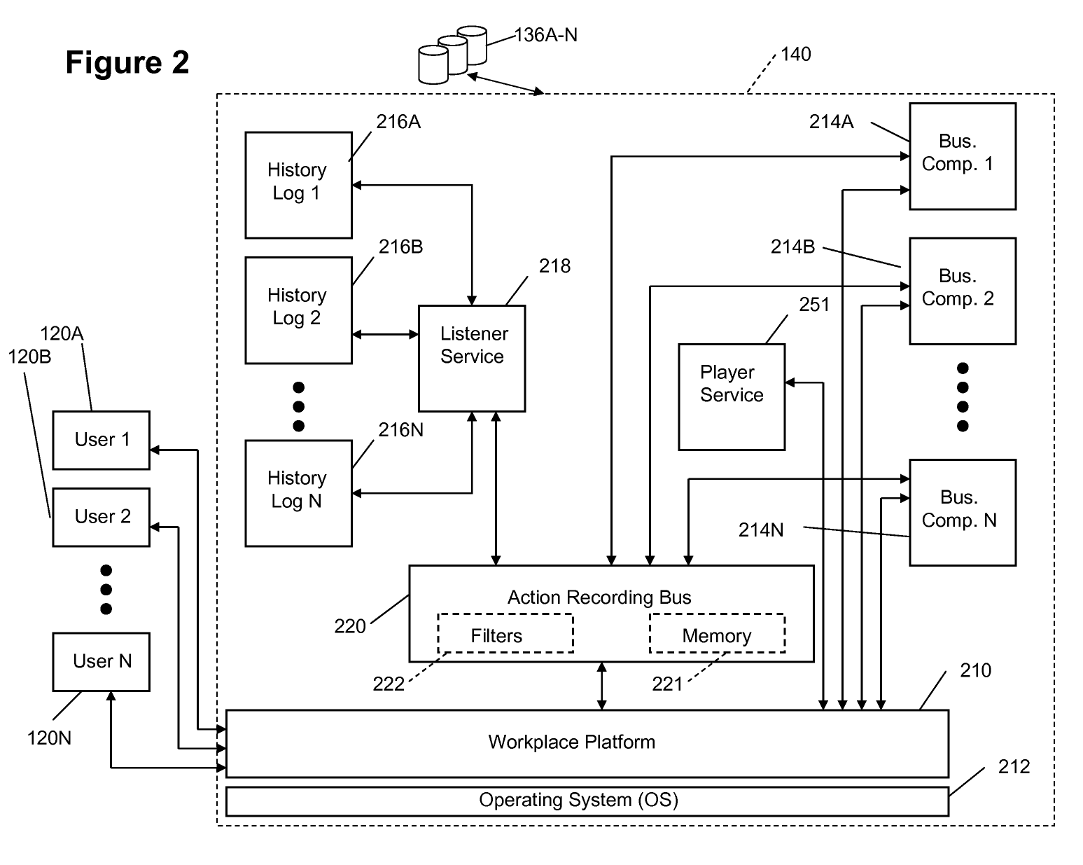

Referring now to FIG. 2, a more detailed illustration of workflow automating server 140 of the present invention is depicted. As can be seen, Users 1-N (120A-120N) connect to the workflow automating server 140 as do databases 136A-N. Databases 136A-N could have computers 134A-134N associated with them per FIG. 1 but are shown here without associated computers for simplicity sake. As can be seen, workflow automating server 140 comprises a Workplace Platform 210 running on top of Operating System (OS) 212. OS 212 could be of any type such as, for instance, the Linux® operating system. The type of OS is not particularly important to describe the concepts of the present invention. Also communicating with the Workplace Platform 210, besides Users 1-N (120A-120N) and OS 212, are Business Components 1-N 214A, 214B, 214N which may be, in turn, communicating with databases 136A-N. “Components”, for purposes of this specification, are basic building blocks of an application and, in the preferred embodiment, of a Lotus® Workplace application. A “Business Component” is a building block which encapsulates a business concept or process. Some examples are: mailbox, discussion, trouble ticket, search capability and document management. Business Components, when used together, can build applications such as help desk which, as noted above, may comprise mailbox, discussion, trouble ticket and search business components. Each business component can be deployed independently of other components as it is not dependent upon them for its usefulness.

Also included in the workflow automating server 140 of the present invention is a new Action Recording Bus 220. The Action Recording Bus 220 records, or stores into memory 221, actions taken by the users 120A, B-N. (This can also be handled by the IBM Lotus Workplace Property Broker which is detailed in the reference identified above.) Examples of actions taken by users 120A, B-N are viewing and responding to email, participating in an instant messaging conversation, or accessing and taking actions in a database. In other words, the user's actions by way of keystrokes are all recorded—not unlike other well-known recording equipment—but, in this case, the recording is accomplished in an environment, that is, a heterogeneous multidatabase, multicomputer environment, which, previously, was not even possible. Users 120A, 120B-120N perform actions in order to get their work accomplished and Action Recording Bus 220 “listens” and records all actions in Memory 221 taken by Users 120A, 120B-120N and responses by Business Components 214A, 214B-214N. Action Recording Bus 220 comprises Filters 222. Filters 222 allow a User 120A-N to customize which parameters, aspects, or steps are recorded by the Action Recording Bus 220 as some are not needed or desired to be recorded. However, each and every keystroke and action that the User 120A-N wishes to record is recorded in the Memory 221 and then, once completed, can be downloaded to the client User computer 120A-N. The User is able to choose which steps are recorded—this basic capability is well known in the art and will not be discussed further here.

Also illustrated in FIG. 2 is a Player Service 251 which is connected to Workplace Platform 210. Player Service 251 receives, from the History Logs 216A-216N, the record of the actions performed and the actions steps taken by Users 120A-120N as well as the modifications made by Users 120A-120N, and “plays” or instructs the Operating System to perform the actions or take the action steps stored and/or modified in the record by Users 120A-120N. This allows the user to, at the first step, to record a method/process/workflow, to amend the steps (that is to say, delete steps, add steps, assign steps, amend prerecorded steps, etc.) and to instruct the player to begin performing the recorded workflow.

In order for this information to be useful, however, it needs to be saved in a coherent manner, such as in a history log. Presently, history logs of application servers and platforms are not sufficient for recording data as there is no normalization of what data is actually being recorded. Some components are just recording the fact that something has happened but not explicitly what exactly happened or how it happened and others are recording more granular information. Also logs are generally targeted at administrators, rather than the ultimate end users, and are used to keep track of software issues and to verify certain things have been executed, etc., as opposed to tracking what has transpired. Using regular system logs or traces is insufficient for automating workflows.

As part of this invention, a new data schema (“Action Recording Schema”) is introduced. The Action Recording Schema describes the data to be recorded in order for later use in automating workflows. One implementation of this invention in a component based software system is described below. Further, it would be useful to have a workflow editor which may be used by the end user to edit an existing workflow to add/delete/assign/change steps in an existing/saved workflow. This will be discussed in further detail below.

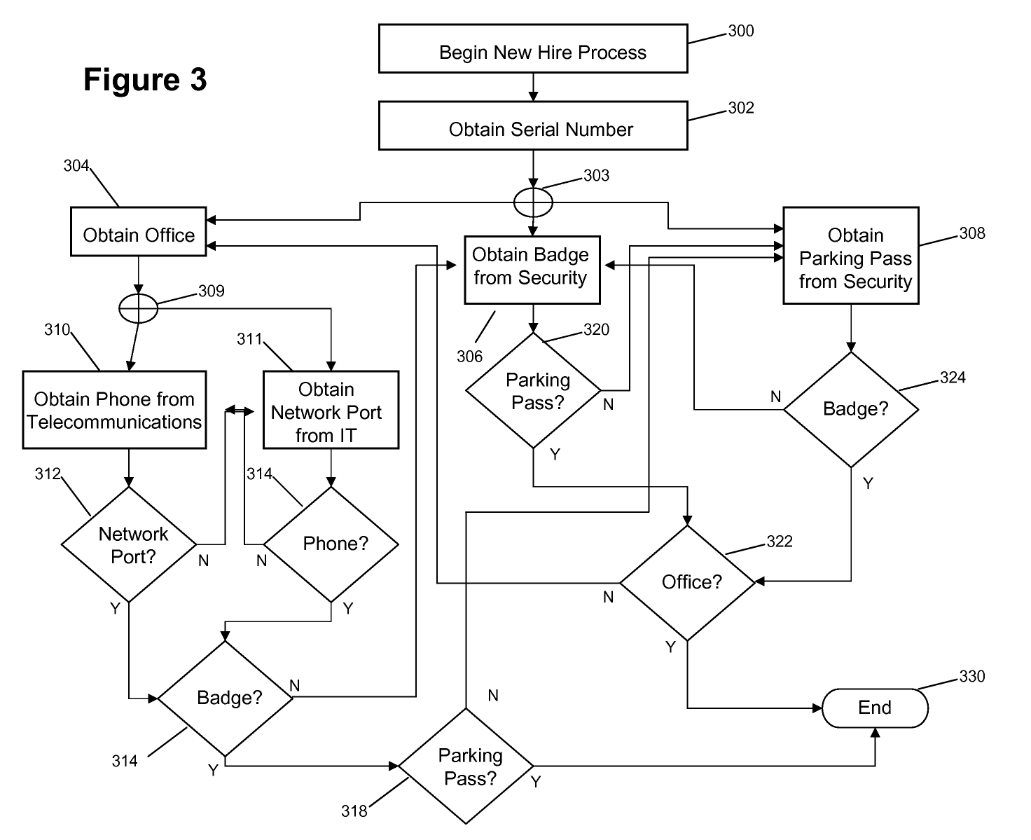

The present invention provides a solution to allow people to create a workflow from work they have just done or work they plan to do, and integrate it into their work system. FIG. 3 illustrates an example of a process which may be repeated many times within an organization and can be somewhat ad hoc as there are many different ways of getting the goal accomplished. The example shown in FIG. 3 is the example of hiring a new employee in an organization and some steps which may be required by that organization in order to establish the new employee in his/her new workplace. Referring to the figure, at step 300, the new hire process is initiated. At 302, a serial number is obtained for the new hire. This many times is the first step in this process as all other steps are dependent upon the serial number having been assigned. After the serial number has been obtained, at 303, three other steps must be done either serially or in parallel in any order as none has a dependency on any other. This is represented by the OR function symbol 303. At step 304, an office is obtained. At 309, both a phone 310 and a network port 311 must be obtained in any order represented by the OR function symbol. Assuming the phone is obtained first, step 312 determines whether a network port has been obtained. If not, the process moves to the network port obtaining step 311. Following the network port obtaining step 311, step 314 determines whether a phone has been obtained and, if not, moves to the phone obtaining step 310. If both the phone and the network port have been obtained, step 317 determines whether a badge has been obtained and, if not, the process moves to the badge obtaining step 306. If so, step 318 determines whether a parking pass has been obtained. If not, the process moves to the obtaining a parking pass step 308. If so, this new hire process is completed at 330.

At step 306, a badge is obtained and, at step 320, it is determined whether a parking pass has been obtained. If not, the process moves to the obtaining a parking pass step 308. If so, step 322 determines whether an office has been obtained and, if not, the process moves to the obtaining an office step 304. If so, this new hire process is completed at 330.

At step 308, a parking pass is obtained and, at step 324, it is determined whether a badge has been obtained. If not, the process moves to the obtaining a badge step 306. If so, step 322 determines whether an office has been obtained and, if not, the process moves to the obtaining an office step 304. If so, this new hire process is completed at 330.

It should be noted that many other steps could be added to this basic process, such as obtaining a computer for the new hire, signing the new hire up for orientation, obtaining travel arrangements for the new hire to/from the orientation, etc. However, the example set forth is illustrative of an ad hoc process where there are many tasks to be completed, sometimes in no particular order. In addition, in order to perform the tasks, many different systems and databases may be required, and many people are involved from different departments, playing one or many roles. For instance, to obtain an office or parking pass, a building facilities application/database may need to be accessed and/or personnel may need to be responsible for completing that step. To obtain a badge, building security may need to have that responsibility. The same holds for such steps as obtaining a phone, a network port, a computer, signing up for orientation, making travel arrangements, etc. Each of these steps may require access to multiple different databases and the responsibility for each of these steps may need to be assigned to different personnel in different departments. It would be useful if the workflow process, including all of the steps performed at each of the various databases using various applications by various personnel could be recorded for later use. The workflow automating system of the present invention provides a solution to this problem.

Further, it may be that a manager or other personnel has previously completed a process one or more times and then decides that it would be useful to have that process automated as the process is to be run several or many more times. It would be useful for the manager to have a history log of the steps taken previously (including all of the metadata about each step such as which application/database was used, who was assigned responsibility) so that the manager may pick and choose from the history log, the steps he/she may wish to include in the process in the order he/she wishes to have the steps done. It would also be useful for the manager or workflow developer to have the ability to remove steps from a previous run process, to assign responsibility for a step to another person, or to add or remove dependencies to or from a step. That is, if step 2 has a dependency upon, for instance the completion of step 1, step 1 must be completed before step 2 may be started. More complex dependencies may be required. For instance, if step 1 may have one of a set of many different outcomes, step 2 may depend upon the outcome being one of a subset of the possible outcome set and step 3 could be dependent upon the outcome being any of the remaining possible outcomes of the set. The present invention presents solutions to each of these challenges as well.

As noted above, one of the problems in the state of the art is the lack of a standard format, or normalization, for logs—that is, a running history of what actions were taken, in which order, and the specific details relating to each transaction. Some components merely record the fact that something has happened but not explicitly what action was taken and others are recording more granular information—none of which are normalized. Also logs are generally targeted at administrators and are used to keep track of software issues and to verify certain things have been executed, etc. One of the many improvements offered by the present invention is a basic log record schema (“Action Recording Schema”) which describes the data that needs to be recorded in order to later use that data for automating workflows. Also described is a possible implementation of this invention in a component based software system. The data that is recorded to represent each work step a user is executing needs to be based on a common schema. From a user experience perspective in general all data specified in such schema should be recorded first (all details), and when looking at the recorded data in the workflow editor tool it can be decided which parts of the data are relevant or are points of variability. For the purposes of this application, the data schema for recording work steps will be referred to as the action recording schema.

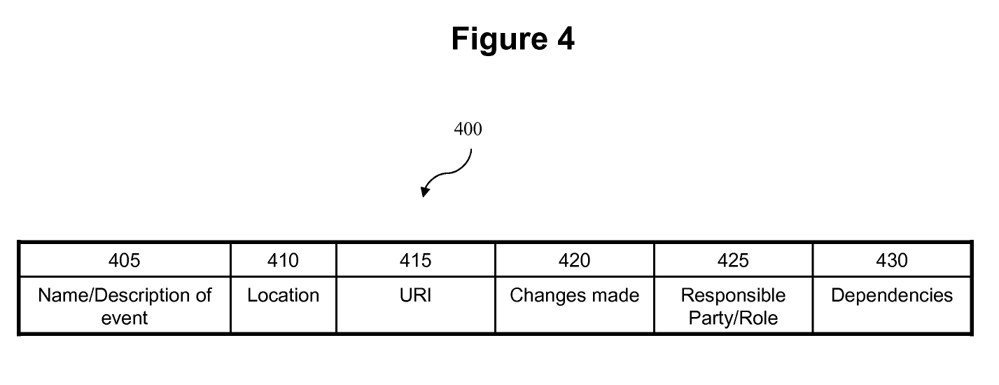

The Action Recording Schema 400 (shown in FIG. 4) has the following parameters, but is no way limited to merely these parameters and can include others:
the general name and description of step 405 that is being recorded so that it can be represented as a human facing activity in a process;
the location 410 as to where to navigate the user at runtime to actually perform the action within an instance of a workflow—this could be either location specific information only, such as an identification (ID) for a user interface (UI) artifact, or it could be UI identification (UID) and specific object type information (content type) as well as any additional identifier required for a specific object type (for a forms based content type, this could be the form template to render the content). Alternatively, it could be the information of which type of object is being worked on in a step and maybe the application to use. With an object type registry it would be able to then launch the correct application at the given step in the process;
a Uniform Resource Identifier (URI) 415 of the content element that the action was executed upon—this information is required later when the work steps are part of a process so that, within a workflow editor, the user can specify whether different steps in the process are supposed to be performed on the exact same content item that may have been created earlier in the process or whether new items are being created in each step;
points of variability—each software component supporting the action recording could specify points of variability for recorded steps, that is, certain data could be recorded but would be changeable in a workflow editor tool. Certain aspects, parameters of the task should be editable in the workflow editor, also some additional settings, e.g. for a “create document” action, an user should be able to specify a specific location or folder that the document needs to be created in; and
changes 420 that were applied to content in a given step—it may be useful to record the changes that were applied to content in a given step so that validation rules could be derived from that in the workflow editor tool. This may or may not be too complex from a user experience perspective, but would provide a powerful solution to simplifying validations for human facing steps as well; and
responsible person/role 425—each step/action needs to have a responsible person or role. It can be as broad as “anyone” or as narrow as “Person having serial #XXXXX”.

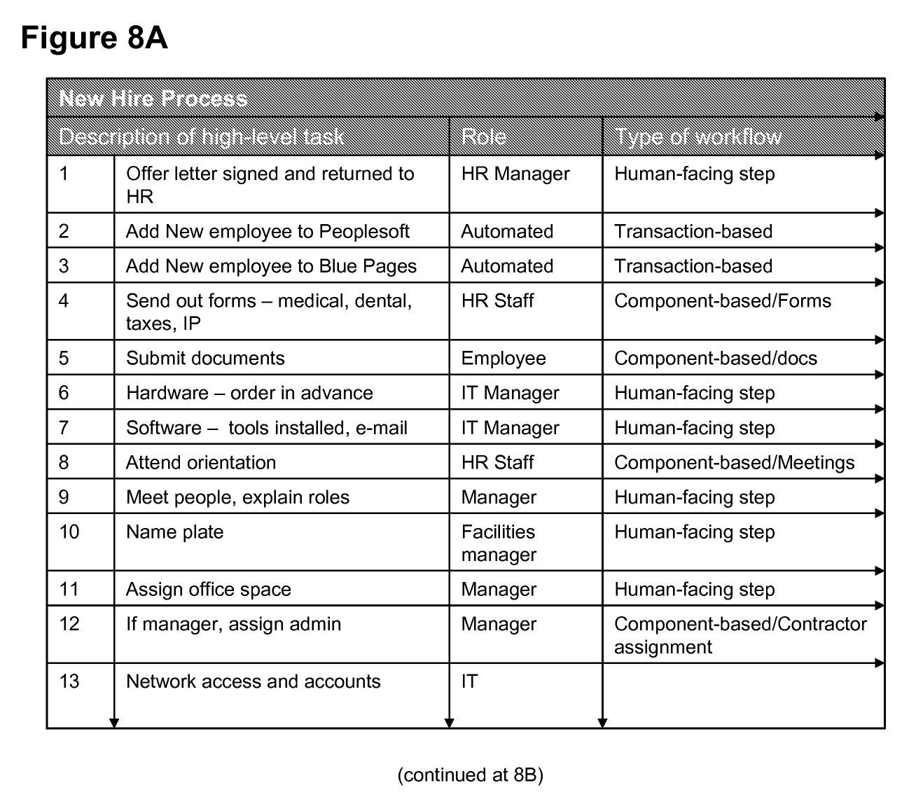

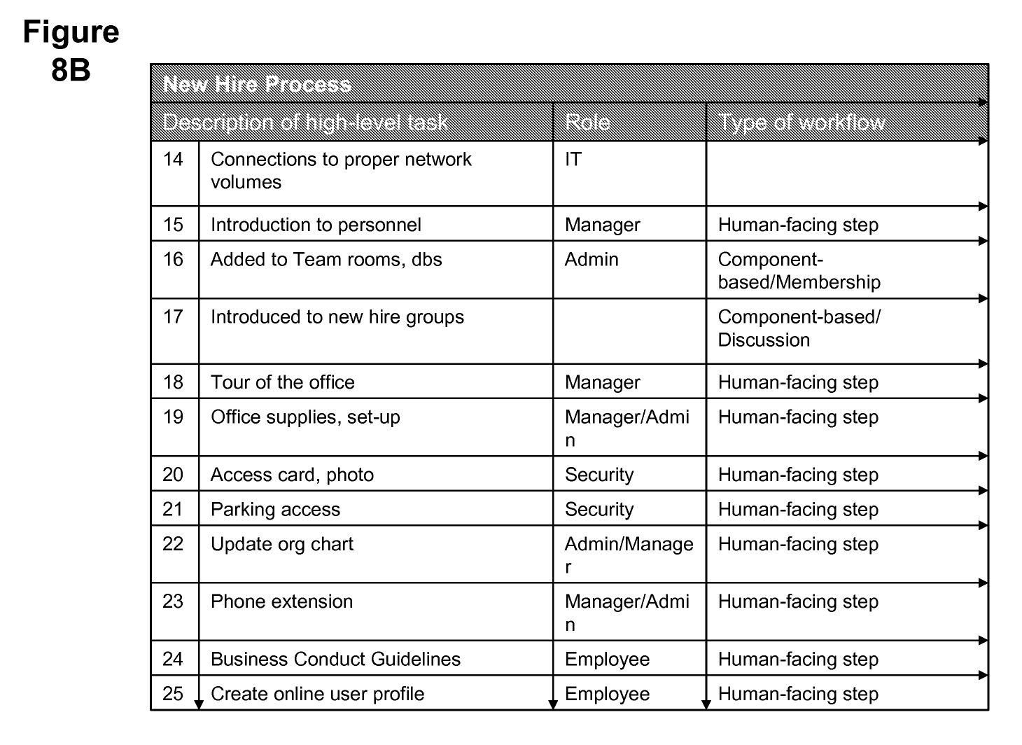

FIG. 8 (comprising FIGS. 8A and 8B) illustrate the various steps necessary for, as an example, hiring a new person. As can be seen, the “Role” column has numerous responsible parties for each step. Utilizing the system of the present invention, the user does not need to intervene in the middle of the process unless directed to do so.

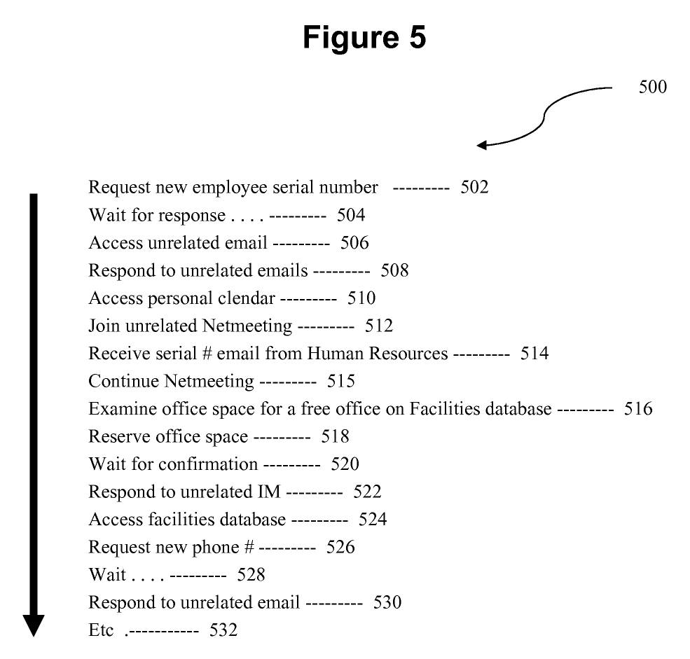

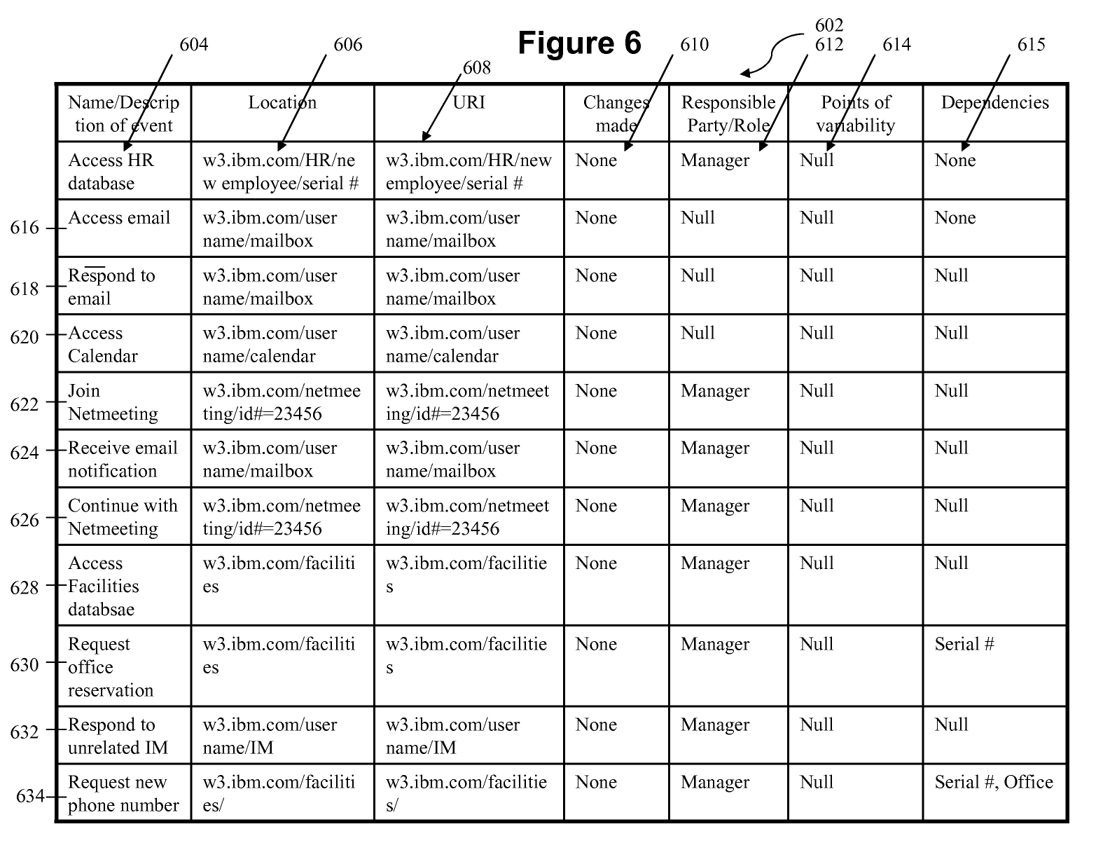

FIG. 5 illustrates an example History Log 500 identifying some of the actions/steps taken by a user in the course of processing a new hire during an otherwise ad hoc day's work. At step 502, user requests a new employee serial number from the human resources department. This can comprise any of a number of steps—depending upon the system implemented by the user's company. In this example, the user accesses the Human Resources database and inputs relevant/necessary information so that the HR can process the request. The history log record for this step is shown in FIG. 6 as record 602. Field 604 identifies the general name and description of the step being recorded (“Access HR database”). Field 606 identifies the location of the HR database which itself has an application which runs independently from Workflow Automating Server 140. URI field 608 has the same location identifier as field 606. Fields 610 and 612 (points of variability and changes made) have a null value as this step has no points of variability and has not been changed at this point. Field 614 identifies the responsible party—the new hire manager—to perform this step while field 616, having a null value, identifies the dependencies required by this step.

Referring back to FIG. 5, the user (the new hiring manager in the present example) waits for a response from the HR department with the new hire's serial number at 504. As is typical in today's work environment, the user must multitask and perform other actions—outside of the new hire process—in order to maintain efficiency in his/her work environment. At step 506, user accesses his/her email and, at 508, user responds to emails. At 510, user accesses his/her calendar and notes that he/she needs to attend a Web Conference (we use the term web conference to denote an electronic meeting, or e-meeting. Some of the commonly used systems for web conferences include SameTime, NetMeeting from Microsoft, Microsoft Live Meeting, WebEx, only to name a few).) and accesses the web conference server to attend the meeting at 512. The History Log records are shown in FIG. 6 as 616, 618, 620, and 622. At 514, user/manager receives an email notification of the assignment of the new employee's serial number. At 515, the user/manager continues with the web conference and, at 516, the user/manager accesses the facilities database and examines the available open office space and reserves an office at 518. These history log records are shown as 624, 626, 628 and 630. A notable field to illustrate is in record 630 where the dependency field 630 shows that the new employee serial number step must be completed prior to step 516 from being completed. At step 520, user/manager waits for confirmation from facilities for the office space and, in the meantime, responds to an instant message from a co-worker—as is typical in today's work environment. At 524, the user/manager accesses the facilities database again to request a new phone number. As noted in record 634, step 524 has responsibility field set to “Manager”—however, this may be modified by user/manager to, for example, “Administrative Assistant” so that the work may be delegated and the manager may perform other higher priority matters. Also note that the dependency field 638 has two dependencies—one is that the obtaining serial number step 502 must be completed as well as the office reservation step 518.

This is example is merely one of an infinite number of different processes/workflows which may be recorded, stored, modified and then reused by end users.

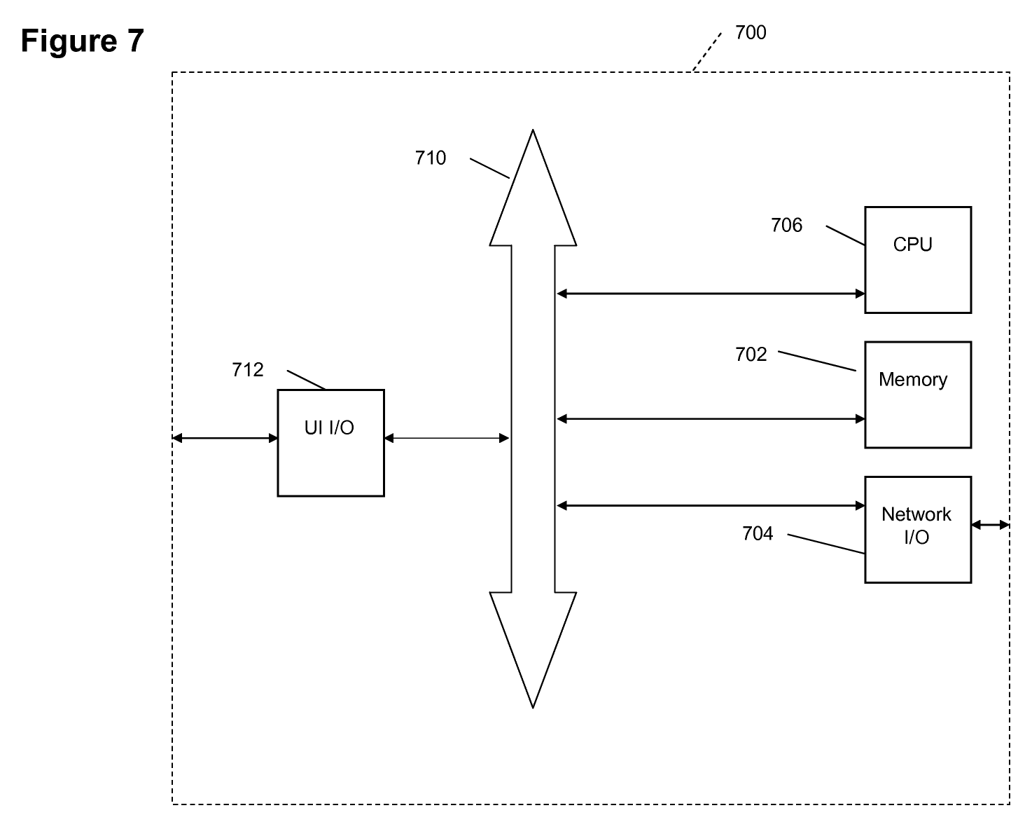

FIG. 7 illustrates a workflow editor tool 700 in a logical block diagram form. The workflow editor tool 700, in the preferred embodiment, is a simple software application, module or component, residing on the user's computer, which accesses the workflow steps—such as those illustrated in FIG. 6—and allows the user to modify/edit each field of each step—allowing, of course, that some fields are not editable by the user. Of course, the workflow editor tool 700 may reside on the workflow automating server 140 or even simply reside on the Internet for easy assess by all by way of Java applet download at time of need. The logical aspects of the workflow editor tool 700 comprise a memory 702 for temporarily storing the workflow steps. Network input/output (I/O) 704 accesses the action recording bus 220 by way of the Workplace Platform 210 and Operating system 212. CPU 706 processes instructions stored in memory 702 as well as those input by user by way of user interface (UI) I/O 712. The components communicated via internal bus 714. The basics of such a tool is all well-known technology and is explained here merely for clarity/thoroughness sake. However, the ability to store normalized action records and the ability to modify and assign them is a new concept.

Many of the steps taken by the user/manager in his/her work day are unnecessary in the new hire process (as shown in FIG. 6) but are almost unavoidable in a typical user's work day. However, using the workflow automating system and method of the present invention, the user is able to perform steps to create a workflow (such steps are automatically recorded according to the filters set by user), to launch the workflow editor tool 700, examine the workflow steps and make modifications as needed. For example, referring again to FIG. 6, steps 616 (accessing email), 618 (responding to email), 620 (accessing calendar) and others, are unnecessary and can be removed from the workflow process. The workflow editor tool 700 allows for this modification. In addition, for instance, step 628 indicates that the manager is responsible for this step. However, the manager may decide that he/she wishes that his/her administrative assistant be responsible for this step. The manager simply makes this modification to step 628 utilizing the workflow editor tool 700 and restores the workflow process in memory 221. (Of course, an internal or external memory store may be utilized to store the workflows.)

The ability to assign responsibility to steps in a workflow process is one of the many novel aspects of the present invention. The assignment may be made to a specific person (by way of email address or serial number for instance) or to a role (such as “manager”, “administrative assistant” or the like). This makes the workflow automating system of the present invention especially powerful as, in today's work environment, multiple parties/roles are responsible in any workflow process. Steps in the workflow can also be executed serially or in parallel (this is a significant distinction between the present invention and tools of the present state of the art such as Apple's Automator or other macro-generating tools).

Because the workflow automating system of the present invention records all steps (which are not filtered by users) in the memory 221 of the Action Recording Bus 220, a user may examine previously implemented process steps, make modifications and save the new workflow process. In addition, the user has the ability to “tag” particular steps which the user may then return a re-use a tagged step in, for example, another workflow process. For instance, if a user is performing his/her day-to-day work and notices that one or more steps which have been taken may be useful in a separate, independent workflow, the user may “tag” the step so that it is easily found sometime later for use in a workflow. Alternatively, the user may immediately move the step to the desired process but, generally, users find this disruptive to their immediate needs and would rather return to construct the process as opposed to interrupting their then ongoing work day.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. In a computer system comprising an operating system, a platform and components, the platform, the operating system and the components being connected for communicating with one another, the system further connected to databases, other operating systems and applications and at least one user connected to and communicating with the computer system, the at least one user performing actions by utilizing the operating system, platform, components, databases, other operating systems or applications, a workflow automating system connected to the computer system to allow the users to create a workflow process in an ad hoc user work environment comprising:
an action recording bus having at least one memory for temporarily storing actions performed by the at least one user connected to the components and the platform and further connected to the users through the platform and the operating system;
a listener service connected to the action recording bus for retrieving from the action recording bus memory the record of actions performed by the at least one user; and
at least one history log connected to the listener service for saving a record of the actions taken by the at least one user recorded by the action recording bus, the record comprising a workflow automated process.

2. The workflow automating system according to claim 1, wherein the action recording bus further comprises one or more filters associated to the at least one user, the one or more filters may be customized by the at least one user so that the user may dictate to filters which specific actions or class of actions are stored by the action recording bus.

3. The workflow automating system according to claim 1 wherein the at least one history log associated with the at least one user's actions may be examined by the at least one user and further wherein the at least one user may edit the at least one history log to add or delete actions previously performed or action steps previously taken by the at least one user and recorded in the at least one history log to record an automated workflow process.

4. The workflow automating system according to claim 1 wherein the at least one history log associated with the at least one user's actions may be examined by the at least one user and further wherein the at least one user may tag one or more actions recorded in the at least one history log for use in an automated workflow process.

5. The workflow automating system according to claim 1 further comprising an automated workflow process player for receiving the record stored in the at least one history log and, at the command of the at least one user, playing the steps stored in the record so as to automatically replaying the actions performed by or action steps previously taken by the at least one user without the at least one user's involvement.

6. The workflow automating system according to claim 3 further comprising an automated workflow process editor comprising a CPU, a memory for temporarily storing the record stored in the at least one history log, an input/output mechanism for allowing the editor to communicate with the at least one history log to receive the record stored by the at least one history log, a user interface module for providing an interface to the at least one user so that the user may examine the record and make changes, additions or deletions to the record, and a bus for allowing the CPU, the memory, user interface module and the input/output mechanism to communicate with one another.

7. The workflow automating system according to claim 6 wherein the editor further comprises an assignment module for receiving instructions from the at least one user to allow the at least one user to assign an action performed or an action step taken previously by the at least one user to another user or user role.

8. The workflow automating system according to claim 1 wherein the record of the at least one history log stores the records in an action recording schema, the schema comprising a name field which identifies the step recorded, a party/parties/party role responsible field to identify the party/parties/party role who/which owns the responsibility to perform the action or take the action step, the schema further comprising a dependency field to identify dependency action or steps required prior to a previous step.

9. In a computer system comprising an operating system, a platform, a listener service, an action recording bus connected to the platform for listening to actions performed by the at least one user, the action recording bus having at least one memory for temporarily storing actions performed by the at least one user, at least one history log connected to the listener service for saving a record of the actions taken by the at least one user recorded by the action recording bus, the record comprising a workflow automated process and components, the platform, the operating system and the components being connected for communicating with one another, the system further connected to databases, other operating systems and applications and at least one user connected to and communicating with the computer system, the at least one user performing actions by utilizing the operating system, platform, components, databases, other operating systems or applications, a method for recording a workflow process for a user operating in an ad hoc user work environment comprising:
listening to actions on the action recording bus performed by the at least one user;
recording the actions in the history log performed by the user;
moving, upon instruction from the user, the history log to player service for playing;
receiving, at the player, instructions from the user to play the actions;
and performing the workflow.

10. The workflow automating method according to claim 9 wherein the action recording bus further comprises one or more filters associated to the at least one user, the one or more filters may be customized by the at least one user so that the user may dictate to filters which specific actions or class of actions are stored by the action recording bus.

11. The workflow automating method according to claim 9 wherein the at least one history log associated with the at least one user's actions may be examined by the at least one user and further wherein the at least one user may edit the at least one history log to add or delete actions previously performed or action steps previously taken by the at least one user and recorded in the at least one history log to record an automated workflow process using a workflow process editor.

12. The workflow automating method according to claim 9 wherein the at least one history log associated with the at least one user's actions may be examined by the at least one user and further wherein the at least one user may tag one or more actions recorded in the at least one history log for use in an automated workflow process.

13. The workflow automating method according to claim 12 wherein the system further comprises an automated workflow process editor comprising a CPU, a memory for temporarily storing the record stored in the at least one history log, an input/output mechanism for allowing the editor to communicate with the at least one history log to receive the record stored by the at least one history log, a user interface module for providing an interface to the at least one user so that the user may examine the record and make changes, additions or deletions to the record, and a bus for allowing the CPU, the memory, user interface module and the input/output mechanism to communicate with one another.

14. The workflow automating method according to claim 12 wherein the editor further comprises an assignment module for receiving instructions from the at least one user to allow the at least one user to assign an action performed or an action step taken previously by the at least one user to another user or user role.

15. The workflow automating method according to claim 9 wherein the record of the at least one history log stores the records in an action recording schema, the schema comprising a name field which identifies the step recorded, a party/parties/party role responsible field to identify the party/parties/party role who/which owns the responsibility to perform the action or take the action step, the schema further comprising a dependency field to identify dependency action or steps required prior to a previous step and a field which specifies changes made.

16. A computer program product in a computer readable medium for operating in a system comprising an operating system, a platform, a listener service, an action recording bus connected to the platform for listening to actions performed by the at least one user, the action recording bus having at least one memory for temporarily storing actions performed by the at least one user, at least one history log connected to the listener service for saving a record of the actions taken by the at least one user recorded by the action recording bus, the record comprising a workflow automated process and components, the platform, the operating system and the components being connected for communicating with one another, the system further connected to databases, other operating systems and applications and at least one user connected to and communicating with the computer system, the at least one user performing actions by utilizing the operating system, platform, components, databases, other operating systems or applications, a method for recording a workflow process for a user operating in an ad hoc user work environment comprising:
listening to actions on the action recording bus performed by the at least one user;
recording the actions in the history log performed by the user;
moving, upon instruction from the user, the history log to player service for playing;
receiving, at the player, instructions from the user to play the actions; and
and performing the workflow.

17. The computer program product according to claim 16 wherein the action recording bus further comprises one or more filters associated to the at least one user, the one or more filters may be customized by the at least one user so that the user may dictate to filters which specific actions or class of actions are stored by the action recording bus.

18. The computer program product according to claim 16 wherein the at least one history log associated with the at least one user's actions may be examined by the at least one user and further wherein the at least one user may edit the at least one history log to add or delete actions previously performed or action steps previously taken by the at least one user and recorded in the at least one history log to record an automated workflow process using a workflow process editor.

19. The computer program product according to claim 16 wherein the at least one history log associated with the at least one user's actions may be examined by the at least one user and further wherein the at least one user may tag one or more actions recorded in the at least one history log for use in an automated workflow process.
